(19) United States
(12) Patent Application Publication
(10) Pub. No.: US 2022/0343086 A1
(43) Pub. Date: Oct. 27, 2022

(54) MACHINE TRANSLATION DEVICE, MACHINE TRANSLATION METHOD, MACHINE TRANSLATION PROGRAM, AND NON-TRANSITORY STORAGE MEDIUM

(71) Applicant: NIPPON TELEGRAPH AND TELEPHONE CORPORATION, Tokyo (JP)

(72) Inventor: Satoshi SUZUKI, Tokyo (JP)

(73) Assignee: NIPPON TELEGRAPH AND TELEPHONE CORPORATION, Tokyo (JP)

(21) Appl. No.: 17/626,053

(22) PCT Filed: Jul. 11, 2019
(86) PCT No.: PCT/JP2019/027543

§ 371 Date: Jul. 1, 2022

(51) Int. Cl. G06F 40/58

(52) U.S. Cl. CPC G06F 40/58

(57) ABSTRACT

The present invention makes it possible to realize highly-accurate machine translation even if a large amount of translation data cannot be prepared. An input unit (112) receives input of an input sentence, which is a sentence that includes at least one or more word and is constituted by a word in a first language, a first compression unit (102) compresses the input sentence to a first compressed expression using a first compressor that compresses a first-language sentence, which is a sentence that includes at least one or more words and is constituted by a word in the first language, to the first compressed expression, the first compressed expression being an expression in the first language obtained by compressing the first-language sentence, a conversion unit (110) converts the first compressed expression of the input sentence into a second compressed expression using a converter that converts the first compressed expression into the second compressed expression, the second compressed expression being an expression in a second language obtained by compressing a second-language sentence, which is a sentence that includes at least one or more words and is constituted by a word in a second language, and a second decompression unit (107) decompresses the second compressed expression to an output sentence, which is the second-language sentence, using a second decompressor for decompressing the second compressed expression to an uncompressed expression.

### TECHNICAL FIELD

The present disclosure relates to a machine translation apparatus, a machine translation method, a machine translation program, and a non-transitory storage medium.

### BACKGROUND ART

Conventionally, a machine translation technique for converting a first language into a second language has been studied. For example, as shown in FIG. 1, there is a technique (e.g., NPL 1) in which a sentence composed of a language A, which is a first language, is translated to a sentence composed of a language B, which is a second language, using a learned compression/decompression model (the compressor and decompressor shown in FIG. 1).

### CITATION LIST

### Patent Literature

[NPL 1] [online], OpenNMT, [searched for on Jun. 1, 2019], Internet <URL: http://opennmt.net>

### SUMMARY OF THE INVENTION

### Technical Problem

However, with the conventional machine translation technique, there has been a problem in that although the compression/decompression model is learned using translation data, which is a pair composed of an original sentence in the first language and a translation using the second language of the original, it is not easy to collect a large amount of translation data. For this reason, there has been a problem in that highly-accurate machine translation cannot be realized if translation data cannot be sufficiently collected.

The technique of the disclosure was made in view of the above-described points, and aims to provide a machine translation apparatus, a machine translation method, a machine translation program, and a non-transitory storage medium, according to which it is possible to realize highly-accurate machine translation even if a large amount of translation data cannot be prepared.

### Means for Solving the Problem

A first aspect of the present disclosure is a machine translation apparatus including: an input unit configured to receive input of an input sentence, which is a sentence that includes at least one or more words and is constituted by a word in a first language; a first compression unit configured to compress the input sentence to a first compressed expression using a first compressor configured to compress a first-language sentence, which is a sentence that includes one or more words and is constituted by a word in the first language, to the first compressed expression, the first compressed expression being an expression in the first language obtained by compressing the first-language sentence; a conversion unit configured to convert the first compressed expression of the input sentence into a second compressed expression using a converter configured to convert the first compressed expression into the second compressed expression, the second compressed expression being an expression in a second language obtained by compressing a second-language sentence, which is a sentence that includes at least one or more words and is constituted by a word in the second language; and a second decompression unit configured to decompress the second compressed expression converted by the conversion unit to an output sentence, which is the second-language sentence, using a second decompressor for decompressing the second compressed expression to an uncompressed expression.

A second aspect of the present disclosure is a machine translation method including: receiving, by a receiving unit, input of an input sentence, which is a sentence that includes at least one or more words and is constituted by a word in a first language; compressing, by a first compression unit, the input sentence to a first compressed expression using a first compressor configured to compress a first-language sentence, which is a sentence that includes at least one or more words and is constituted by a word in the first language, to the first compressed expression, the first compressed expression being an expression in the first language obtained by compressing the first-language sentence; converting, by a conversion unit, the first compressed expression of the input sentence into a second compressed expression using a converter configured to convert the first compressed expression into the second compressed expression, the second compressed expression being an expression in a second language obtained by compressing a second-language sentence, which is a sentence that includes at least one or more words and is constituted by a word in the second language; and decompressing, by a second decompression unit, the second compressed expression converted by the conversion unit to an output sentence, which is the second-language sentence, using a second decompressor for decompressing the second compressed expression to an uncompressed expression.

A third aspect of the present disclosure is a machine translation program for causing a computer to execute processing including: receiving, by a receiving unit, input of an input sentence, which is a sentence that includes at least one or more words and is constituted by a word in a first language; compressing, by a first compression unit, the input sentence to a first compressed expression using a first compressor configured to compress a first-language sentence, which is a sentence that includes at least one or more words and is constituted by a word in the first language, to the first compressed expression, the first compressed expression being an expression in the first language obtained by compressing the first-language sentence; converting, by a conversion unit, the first compressed expression of the input sentence into a second compressed expression using a converter configured to convert the first compressed expression into the second compressed expression, the second compressed expression being an expression in the second language obtained by compressing a second-language sentence, which is a sentence that includes at least one or more words and is constituted by a word in the second language; and decompressing, by a second decompression unit, the second compressed expression converted by the conversion unit to an output sentence, which is the second-language sentence, using a second decompressor for decompressing the second compressed expression to an uncompressed expression.

A fourth aspect of the present disclosure is a non-transitory storage medium storing a machine translation program for causing a computer to execute: receiving input of an input sentence, which is a sentence that includes at least one or more words and is constituted by a word in a first language; compressing the input sentence to a first compressed expression using a first compressor configured to compress a first-language sentence, which is a sentence that includes at least one or more words and is constituted by a word in the first language, to the first compressed expression, the first compressed expression being an expression in the first language obtained by compressing the first-language sentence; converting the first compressed expression of the input sentence into a second compressed expression using a converter configured to convert the first compressed expression into the second compressed expression, the second compressed expression being an expression in the second language obtained by compressing a second-language sentence, which is a sentence that includes at least one or more words and is constituted by a word in the second language; and decompressing the converted second compressed expression to an output sentence, which is the second-language sentence, using a second decompressor for decompressing the second compressed expression to an uncompressed expression.

### Effects of the Invention

According to the technique of the disclosure, it is possible to realize highly-accurate machine translation even if a large amount of translation data cannot be prepared.

### BRIEF DESCRIPTION OF DRAWINGS

FIG. 1 is a diagram showing an example of conventional machine translation.

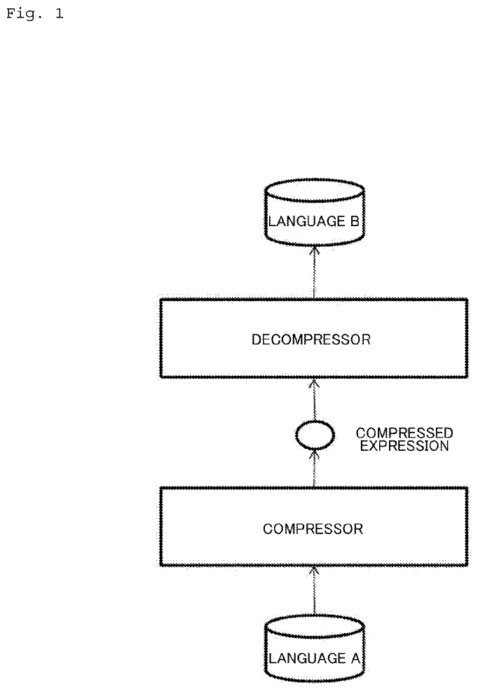

FIG. 2 is a block diagram showing an overall configuration of a computer that functions as a machine translation apparatus according to the present embodiment.

FIG. 3 is a block diagram showing an example of a functional configuration of a machine translation apparatus according to the present embodiment.

FIG. 4 is a conceptual diagram showing a configuration used during learning of compressors and decompressors.

FIG. 5 is a conceptual diagram showing a configuration used during learning of a converter.

FIG. 6 is a conceptual diagram showing an overview of machine translation processing performed by the machine translation apparatus.

FIG. 7 is a flowchart showing a learning processing routine of a machine translation apparatus according to the present embodiment.

FIG. 8 is a flowchart showing a machine translation processing routine of a machine translation apparatus according to the present embodiment.

FIG. 9 is a conceptual diagram showing another configuration used during learning of a converter.

FIG. 10 is a conceptual diagram showing a configuration of a converter used when a mixture learning model is applied.

### DESCRIPTION OF EMBODIMENTS

Hereinafter, embodiments of the present disclosure will be described with reference to the drawings.

### Overview of Machine Translation Apparatus According to Embodiment of Present Disclosure

First, an overview of an embodiment of the present disclosure will be described.

It is known that inter-language word vectors can be associated to a certain degree in linear unsupervised learning (Reference Document 1).
[Reference Document 1] A. Conneau, G. Lample, L. Denoyer, M A. Ranzato, H. Jegou, “Word Translation Without Parallel Data”.

If inter-language word vectors can be associated to a certain degree through linear unsupervised learning, it is possible to expect higher-accuracy association when using non-linear supervised learning. Also, if information compression achieved by an auto-encoder is performed sufficiently, it is possible to realize semantic distance in a vector of a compression dimension even if the input is a sentence, and it is possible to expect a correlative relationship between the change in sentence meaning and the change in the vector of the compression dimension. Accordingly, it is thought that there does not need to be a large amount of translation data for associating the vectors that change smoothly with respect to the sentence meaning using supervised learning. Due to this, using the following method, it is possible to realize a highly-accurate machine translation apparatus based on a relatively small amount of translation data and a large amount of single-language data that is easy to prepare. The following method is performing information compression on a sentence in an input language and a sentence in a target language using auto-encoders, generating vectors that are smooth with respect to the change in sentence meaning, and learning the association therebetween using a small amount of translation sentence data.

### Configuration of Machine Translation Apparatus According to Embodiment of Present Disclosure

Hereinafter, an example of an embodiment of the technique of the disclosure will be described with reference to the drawings. Note that constituent elements and portions that are identical or equivalent in the drawings are denoted by identical reference numerals. Also, the dimensional proportions in the drawings are exaggerated for convenience in the description, and are different from the actual proportions in some cases.

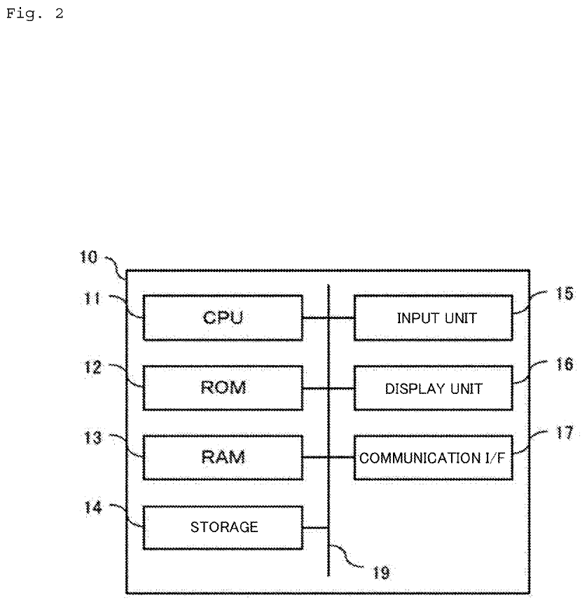

FIG. 2 is a block diagram showing a hardware configuration of a machine translation apparatus 10 according to the present embodiment. As shown in FIG. 2, the machine translation apparatus 10 includes a CPU (Central Processing Unit) 11, a ROM (Read Only Memory) 12, a RAM (Random Access Memory) 13, a storage 14, an input unit 15, a display unit 16, and a communication interface (I/F) 17. The configurations are connected via a bus 19 so as to be able to communicate with each other.

The CPU 11 is a central processing unit, and executes various programs and controls the units. That is, the CPU 11 reads out a program from the ROM 12 or the storage 14 and executes the program using the RAM 13 as a work area. The CPU 11 performs control of the above-described configurations and various types of computation processing in accordance with a program stored in the ROM 12 or the storage 14. In the present embodiment, the ROM 12 or the storage 14 stores a machine translation program for executing learning processing and machine translation processing.

The ROM 12 stores various types of programs and various types of data. The RAM 13 temporarily stores programs or data as a work area. The storage 14 is constituted by an HDD (Hard Disk Drive) or an SSD (Solid State Drive), and stores various types of programs including an operating system, and various types of data.

The input unit 15 includes a pointing device such as a mouse and a keyboard, and is used to perform various types of input.

The display unit 16 is, for example, a liquid crystal display, and displays various types of information. The display unit 16 may also function as an input unit 15 by employing a touch panel scheme.

The communication interface 17 is an interface for communicating with another device, and for example, a standard such as Ethernet (registered trademark), FDDI, or Wi-Fi (registered trademark) is used.

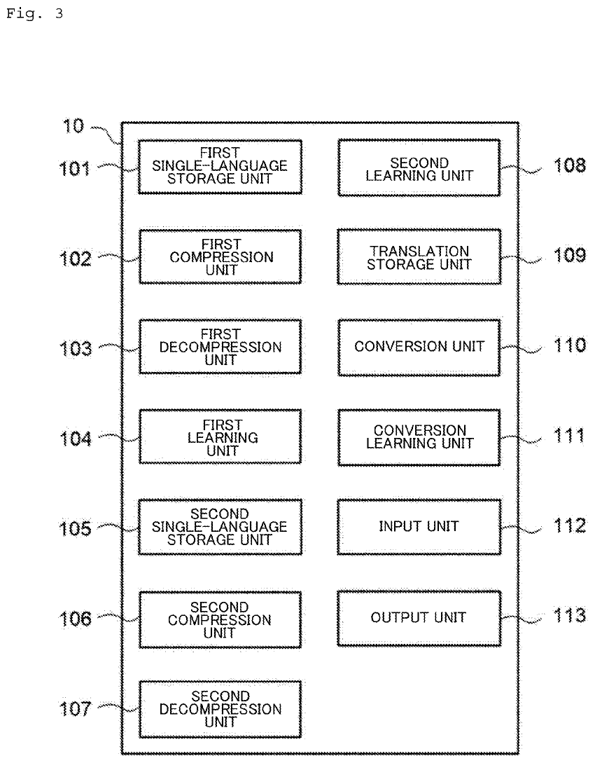

Next, a functional configuration of the machine translation apparatus 10 will be described. FIG. 3 is a block diagram showing an example of the functional configuration of the machine translation apparatus 10. As shown in FIG. 3, the machine translation apparatus 10 includes, as a functional configuration, a first single-language storage unit 101, a first compression unit 102, a first decompression unit 103, a first learning unit 104, a second single-language storage unit 105, a second compression unit 106, a second decompression unit 107, a second learning unit 108, a translation storage unit 109, a conversion unit 110, a conversion learning unit 111, an input unit 112, and an output unit 113. The functional configurations are realized by the CPU 11 reading out a machine translation program stored in the ROM 12 or the storage 14, expanding the read-out program to the RAM 13, and executing the program. Hereinafter, learning processing for compressors, decompressors, and a converter will be described, and thereafter, machine translation processing will be described.

Learning Processing

First, learning processing performed by the machine translation apparatus 10 will be described.

The first single-language storage unit 101 stores multiple first-language sentences, which include at least one or more words and are constituted by words in a first language. In the present disclosure, it is assumed that a “sentence” encompasses a single word, a single sentence, and multiple sentences.

The first compression unit 102 compresses the input first-language sentence to a first compressed expression using a first compressor that compresses a first-language sentence to the first compressed expression, the first compressed expression being an expression in the first language obtained by compressing the first-language sentence. Specifically, the first compression unit 102 first acquires the first-language sentence from the first single-language storage unit 101. Next, the first compression unit 102 generates the first compressed expression obtained by compressing the first-language sentence using the first compressor. The first compressor is any neural network, and for example, an LSTM (Long short-time memory), a GRU (Gated Recurrent Unit), or a multilayer perceptron (MLP) can be employed thereas. Any initial value or initial values that are all set to “0” is used as the parameter of the first compressor. The first compressed expression is a first-language sentence that has been dimensionally compressed by the first compressor. Also, the first compression unit 102 transfers the generated first compressed expression to the first decompression unit 103. Also, the first compression unit 102 transfers the acquired first-language sentence to the first learning unit 104.

The first decompression unit 103 decompresses the first compressed expression compressed by the first compression unit 102 to a first decompressed sentence, which is the first-language sentence, using a first decompressor for decompressing the first compressed expression to an uncompressed expression. Specifically, the first decompression unit 103 generates a first decompressed sentence obtained by decompressing the first compressed expression to the first-language sentence, using the first decompressor. The first decompressor is any neural network, and for example, an LSTM, a GRU, or an MLP can be employed thereas. Any initial value or initial values that are all set to “0” is used as the parameter of the first decompressor. Also, the first decompression unit 103 transfers the generated first decompressed sentence to the first learning unit 104.

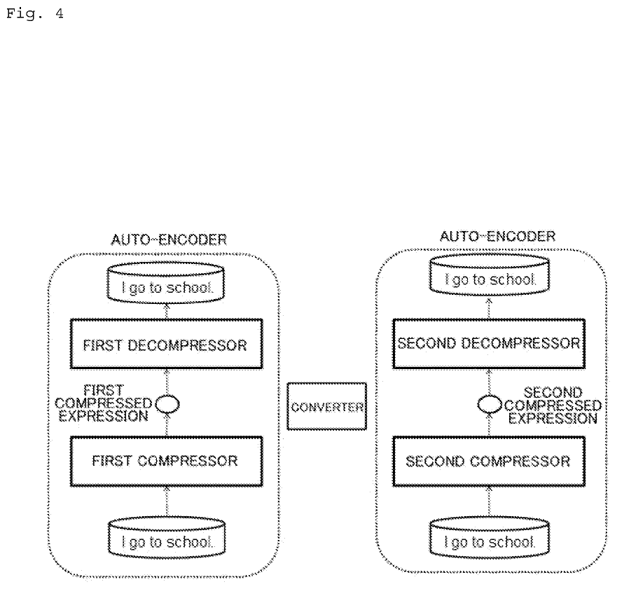

The first learning unit 104 learns the first compressor and the first decompressor such that the input first-language sentence and the first decompressed sentence decompressed by the first decompression unit 103 match. Specifically, the first learning unit 104 learns the parameters of the first compressor and the parameters of the first decompressor using, for example, an error back-propagation method, such that the first-language sentence received from the first compression unit 102 and the first decompressed sentence decompressed by the first decompression unit 103 match. FIG. 4 shows configurations of the first compressor and the first decompressor (left side of FIG. 4). As shown in FIG. 4, an auto-encoder using a neural network can be formed by the first compressor and the first decompressor. If the first language is English, the first compressed expression is generated by compressing the first-language sentence “I go to school.” using the first compressor. The first decompressed sentence “I go to school.” obtained by decompressing the first compressed expression is output by the first decompressor. The first learning unit 104 learns the parameters of the first compressor and the parameters of the first decompressor such that the first-language sentence and the first decompressed sentence match. The first learning unit 104 repeats the learning of the parameters of the first compressor and the parameters of the first decompressor until an end condition is satisfied. Then, the first learning unit 104 transfers the learned parameters of the first compressor to the first compression unit 102 and transfers the learned parameters of the first decompressor to the first decompression unit 103.

The second single-language storage unit 105 stores multiple second-language sentences, which include at least one or more words and are constituted by words in a second language.

The second compression unit 106 compresses the input second-language sentence to a second compressed expression using a second compressor that compresses a second-language sentence to the second compressed expression, the second compressed expression being an expression in the second language obtained by compressing the second-language sentence.

Specifically, the second compression unit 106 first acquires the second-language sentence from the second single-language storage unit 105. Next, the second compression unit 106 generates the second compressed expression obtained by compressing the second-language sentence using the second compressor. The second compressor is any neural network, and for example, an LSTM, a GRU, or an MLP can be employed thereas. Any initial value or initial values that are all set to “0” is used as the parameter of the second compressor. The second compressed expression is a second-language sentence that has been dimensionally compressed by the second compressor.

Also, the second compression unit 106 transfers the generated second compressed expression to the second decompression unit 107. Also, the second compression unit 106 transfers the acquired second-language sentence to the second learning unit 108.

The second decompression unit 107 decompresses the second compressed expression compressed by the second compression unit 106 to a second decompressed sentence, which is the second-language sentence, using a second decompressor for decompressing the second compressed expression to an uncompressed expression. Specifically, the second decompression unit 107 generates a second decompressed sentence obtained by decompressing the second compressed expression to the second-language sentence, using the second decompressor. The second decompressor is any neural network, and for example, an LSTM, a GRU, or an MLP can be employed thereas. Any initial value or initial values that are all set to “0” is used as the parameter of the second decompressor. Also, the second decompression unit 107 transfers the generated second decompressed sentence to the second learning unit 108.

The second learning unit 108 learns the second compressor and the second decompressor such that the input second-language sentence and the second decompressed sentence decompressed by the second decompression unit 107 match. Specifically, the second learning unit 108 learns the parameters of the second compressor and the parameters of the second decompressor using, for example, an error back-propagation method, such that the second-language sentence received from the second compression unit 106 and the second decompressed sentence decompressed by the second decompression unit 107 match. FIG. 4 shows configurations of the second compressor and the second decompressor (right side of FIG. 4). As shown in FIG. 4, an auto-encoder using a neural network can be formed by the second compressor and the second decompressor. If the second language is Japanese, the second compressed expression is generated by compressing the second-language sentence [symbol] [symbol] using the second compressor. The second decompressed sentence [symbol] obtained by decompressing the second compressed expression is output by the second decompressor. The second learning unit 108 learns the parameters of the second compressor and the parameters of the second decompressor such that the second-language sentence and the second decompressed sentence match. The second learning unit 108 repeats the learning of the parameters of the second compressor and the parameters of the second decompressor until an end condition is satisfied. Then, the second learning unit 108 transfers the learned parameters of the second compressor to the second compression unit 106 and transfers the learned parameters of the second decompressor to the second decompression unit 107.

The translation storage unit 109 stores multiple pieces of translation data, which is a pair consisting of the original sentence, which is the first-language sentence, and a translation using the second-language sentence of the original sentence.

The conversion unit 110 converts a first original sentence compressed expression into a second original sentence compressed expression, which is the second compressed expression, using a converter that converts the first compressed expression into the second compressed expression, the first original sentence compressed expression being the compressed expression of the original sentence, which is the first-language sentence. Specifically, the conversion unit 110 first acquires translation data from the translation storage unit 109. Next, the conversion unit 110 uses the first compressor learned by the first learning unit 104 to generate a first original sentence compressed expression, which is an expression obtained by compressing the original sentence of the translation data. More specifically, after the learning performed by the first learning unit 104 has ended, the conversion unit 110 transfers the original sentence to the first compression unit 102 and acquires the first original sentence compressed expression. Next, the conversion unit 110 converts the first original sentence compressed expression into a second original sentence compressed expression, which is the second compressed expression, using the converter. The converter can employ any neural network (e.g., a multilayer perceptron (MLP)) or a mixture learning model. Any initial value is used as the parameter of the converter. Also, the conversion unit 110 generates the translation compressed expression, which is an expression obtained by compressing the translation of the translation data, using the second compressor learned by the second learning unit 108. More specifically, after the learning performed by the second learning unit 108 has ended, the conversion unit 110 transfers the translation to the second compression unit 106 and acquires the translation compressed expression. Then, the conversion unit 110 transfers the second original sentence compressed expression and the translation compressed expression to the conversion learning unit 111.

The conversion learning unit 111 learns the converter such that the second original sentence compressed expression and the translation compressed expression match. Specifically, the conversion learning unit 111 learns the parameters of the converter using, for example, an error back-propagation method or the like, such that the second original sentence compressed expression and the translation compressed expression match.

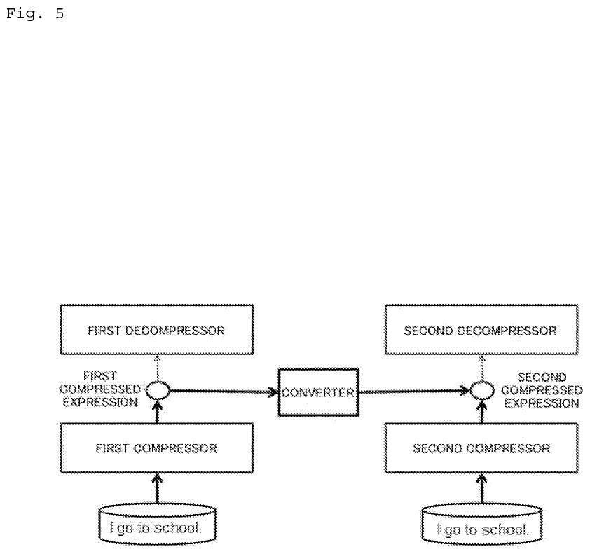

FIG. 5 shows a configuration used during learning of the converter. In FIG. 5, in one example, translation data is used in which the original sentence is the first-language sentence “I go to school.” and the translation is the second-language sentence [symbol] . As shown in FIG. 5, the original sentence is compressed to the first compressed expression (first original sentence compressed expression) by the first compressor, and is converted to the second compressed expression (second original sentence compressed expression) by the converter. Meanwhile, the translation is compressed to the second compressed expression (translation compressed expression) by the second compressor. The conversion learning unit 111 learns the parameters of the converter such that the second original sentence compressed expression and the translation compressed expression match. The conversion learning unit 111 repeats the learning of the parameters of the converter until an end condition is satisfied. Then, the conversion learning unit 111 transfers the learned parameters of the converter to the conversion unit 110. Note that the conversion learning unit 111 may also acquire the translation data and the first original sentence compressed expression from the conversion unit 110 and use them in the learning of the converter.

Machine Translation Processing

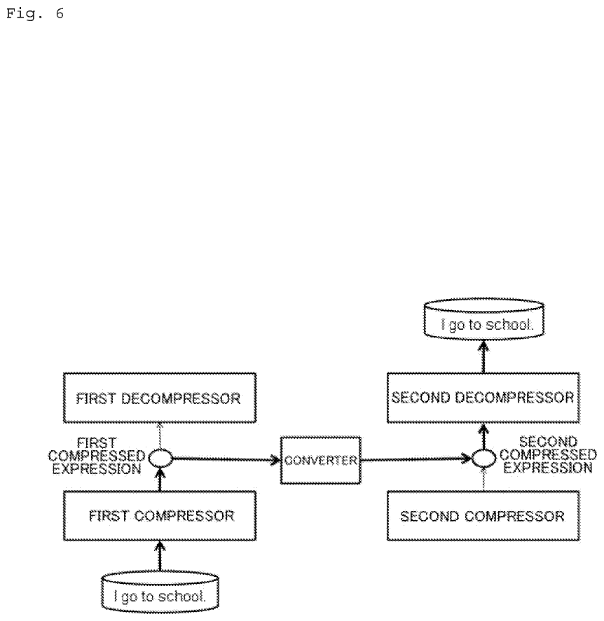

Next, machine translation processing performed by the machine translation apparatus 10 will be described. FIG. 6 is a conceptual diagram showing an overview of machine translation processing performed by the machine translation apparatus 10. As shown in FIG. 6, the machine translation apparatus 10 compresses the first-language sentence to the first compressed expression using the learned first compressor, and converts the first compressed expression into the second compressed expression using the learned converter. Then, the machine translation apparatus 10 translates the first-language sentence by decompressing the second compressed expression to the second-language sentence using the learned second decompressor.

The input unit 112 receives input of an input sentence, which is the first-language sentence. Then, the input unit 112 transfers the received input sentence to the first compression unit 102.

The first compression unit 102 compresses the input sentence to the first compressed expression using the first compressor learned by the first learning unit 104. Then, the first compression unit 102 transfers the first compressed expression of the input sentence resulting from the compression to the conversion unit 110.

The conversion unit 110 converts the first compressed expression of the input sentence into the second compressed expression using the converter learned by the conversion learning unit 111. Then, the conversion unit 110 transfers the second compressed expression of the input sentence resulting from the conversion to the second decompression unit 107.

The second decompression unit 107 decompresses the second compressed expression of the input sentence to an output sentence, which is the second-language sentence, using the second decompressor learned by the second learning unit 108. Then, the second decompression unit 107 transfers the output sentence to the output unit 113.

The output unit 113 outputs the output sentence.

### Operation of Machine Translation Apparatus According to Embodiment of Present Disclosure

Next, an operation performed by the machine translation apparatus 10 will be described.

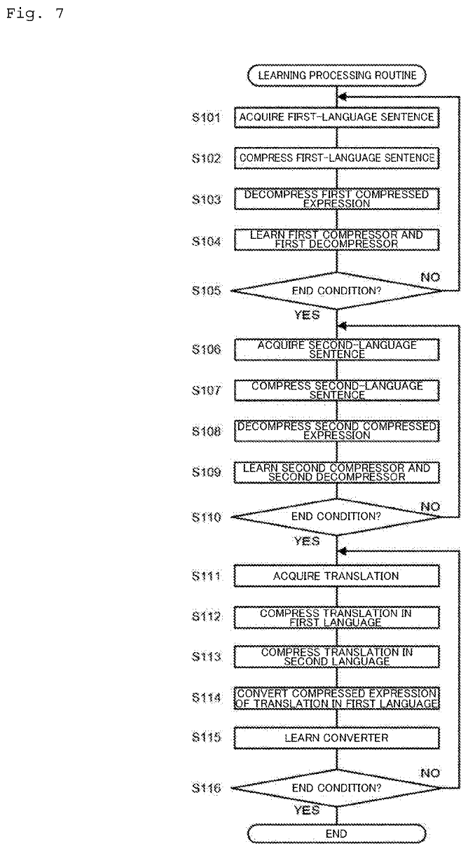

FIG. 7 is a flowchart showing a flow of a learning processing routine performed by the machine translation apparatus 10. The learning processing routine is performed by the CPU 11 reading out a machine translation program from the ROM 12 or the storage 14, expanding the program to the RAM 13, and executing the program.

In step S101, as the first compression unit 102, the CPU 11 acquires, from the first single-language storage unit 101, a first-language sentence, which is a sentence that includes at least one or more words and is constituted by a word in a first language.

In step S102, as the first compression unit 102, the CPU 11 compresses the first-language sentence acquired through step S101 above to the first compressed expression using the first compressor that compresses the first-language sentence to a first compressed expression, which is an expression in the first language obtained by compressing the first-language sentence.

In step S103, as the first decompression unit 103, the CPU 11 decompresses the first compressed expression compressed through step S102 above to the first decompressed sentence, which is the first-language sentence, using the first decompressor for decompressing the first compressed expression to an uncompressed expression.

In step S104, as the first learning unit 104, the CPU 11 learns the first compressor and the first decompressor such that the first-language sentence acquired through step S101 above and the first decompressed sentence decompressed through step S103 above match.

In step S105, as the first learning unit 104, the CPU 11 determines whether or not the end condition has been satisfied.

If the end condition has not been satisfied (NO in step S105 above), the processing returns to step S101.

On the other hand, if the end condition has been satisfied (YES in step S105 above), in step S106, as the second compression unit 106, the CPU 11 acquires the second-language sentence, which is a sentence that includes at least one or more words and is constituted by a word in the second language, from the second single-language storage unit 105.

In step S107, as the second compression unit 106, the CPU 11 compresses the second-language sentence acquired through step S106 above to the second compressed expression using the second compressor that compresses the second-language sentence to a second compressed expression, which is an expression in the second language obtained by compressing the second-language sentence.

In step S108, as the second decompression unit 107, the CPU 11 decompresses the second compressed expression compressed through step S107 above to the second decompressed sentence, which is the second-language sentence, using the second decompressor for decompressing the second compressed expression to an uncompressed expression.

In step S109, as the second learning unit 108, the CPU 11 learns the second compressor and the second decompressor such that the second-language sentence acquired through step S106 above and the second decompressed sentence decompressed through step S108 above match.

In step S110, as the second learning unit 108, the CPU 11 determines whether or not the end condition has been satisfied.

If the end condition has not been satisfied (NO in step S110 above), the processing returns to step S106.

On the other hand, if the end condition has been satisfied (YES in step S110 above), in step S111, as the conversion unit 110, the CPU 11 acquires, from the translation storage unit 109, the translation data, which is a pair consisting of the original sentence, which is the first-language sentence, and the translation constituted by the second-language sentence of the original sentence.

In step S112, as the first compression unit 102, the CPU 11 generates the first original sentence compressed expression, which is an expression obtained by compressing the original sentence of the translation data, using the first compressor learned through step S104 above.

In step S113, as the second compression unit 106, the CPU 11 generates the translation compressed expression, which is an expression obtained by compressing the translation of the translation data, using the second compressor learned through step S109 above.

In step S114, as the conversion unit 110, the CPU 11 converts the first original sentence compressed expression generated through step S112 above into the second original sentence compressed expression, which is the second compressed expression, using the converter that converts the first compressed expression into the second compressed expression.

In step S115, as the conversion learning unit 111, the CPU 11 learns the converter such that the second original sentence compressed expression and the translation compressed expression match.

In step S116, as the conversion learning unit 111, the CPU 11 determines whether or not the end condition has been satisfied.

If the end condition has not been satisfied (NO in step S116 above), the processing returns to step S111.

On the other hand, if the end condition has been satisfied (YES in step S116 above), the CPU 11 ends the processing.

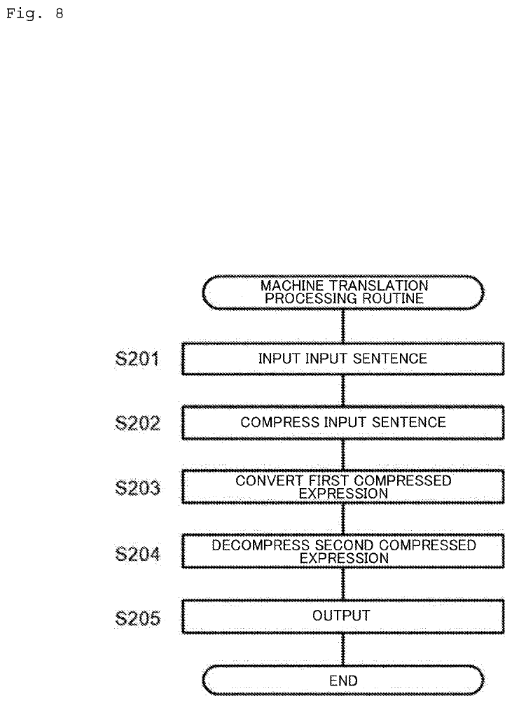

FIG. 8 is a flowchart showing a flow of a machine translation processing routine performed by the machine translation apparatus 10. The machine translation processing routine is performed by the CPU 11 reading out a machine translation program from the ROM 12 or the storage 14, expanding the program to the RAM 13, and executing the program.

In step S201, as the input unit 112, the CPU 11 receives input of an input sentence, which is a first-language sentence.

In step S202, as the first compression unit 102, the CPU 11 compresses the input sentence to the first compressed expression using the first compressor learned by the first learning unit 104.

In step S203, as the conversion unit 110, the CPU 11 converts the first compressed expression of the input sentence to the second compressed expression using the converter learned by the conversion learning unit 111.

In step S204, as the second decompression unit 107, the CPU 11 decompresses the second compressed expression of the input sentence to an output sentence, which is the second-language sentence, using the second decompressor learned by the second learning unit 108.

In step S205, as the output unit 113, the CPU 11 outputs the output sentence and ends the processing.

As described above, the machine translation apparatus according to an embodiment of the present disclosure receives input of an input sentence, compresses the input sentence to a first compressed expression using a first compressor, converts the first compressed expression of the input sentence into a second compressed expression using a converter, and decompresses the second compressed expression converted by the conversion unit to an output sentence, which is a second-language sentence, using a second decompressor. This makes it possible to realize highly-accurate machine translation even if a large amount of translation data cannot be prepared. Here, the input sentence is a sentence that includes at least one or more words and is constituted by a word in a first language. Also, the first compressor compresses a first-language sentence, which is a sentence that includes at least one or more words and is constituted by a word in a first language, to a first compressed expression, which is an expression in the first language obtained by compressing the first-language sentence. Also, the converter converts the first compressed expression into a second compressed expression, which is an expression in the second language obtained by compressing the second-language sentence, which is a sentence that includes at least one or more words and is constituted by a word in the second language. Also, the second decompressor is a decompressor for decompressing the second compressed expression to an uncompressed expression.

Note that the present disclosure is not limited to the above-described embodiment, and various modifications and adaptations are possible without departing from the gist of the invention.

For example, in the above-described embodiment, it was described that the sentence is treated as a word, a simple sentence, or a complex sentence, but there is no limitation to this, and the sentence may also be treated as a word string or a character string.

It is also possible to use a configuration in which, as the learning procedure, the first compressor, the converter, and the second decompressor are learned at the same time using the translation data first, and thereafter the above-described learning processing and the machine translation processing are performed.

In this case, before the following learning, the first learning unit 104, the second learning unit 108, and the conversion learning unit 111 learn the first compressor, the second decompressor, and the converter using the translation data, which is a pair consisting of an original sentence and a translation, such that the following sentence matches the translation of the translation data. Here, the following learning is learning of the first learning unit 104, learning of the second learning unit 108, and learning of the conversion learning unit 111. Also, the following sentence is a sentence obtained by compressing the original sentence of the translation data using the first compression unit 102, converting using the conversion unit 110, and decompressing using the second decompression unit 107.

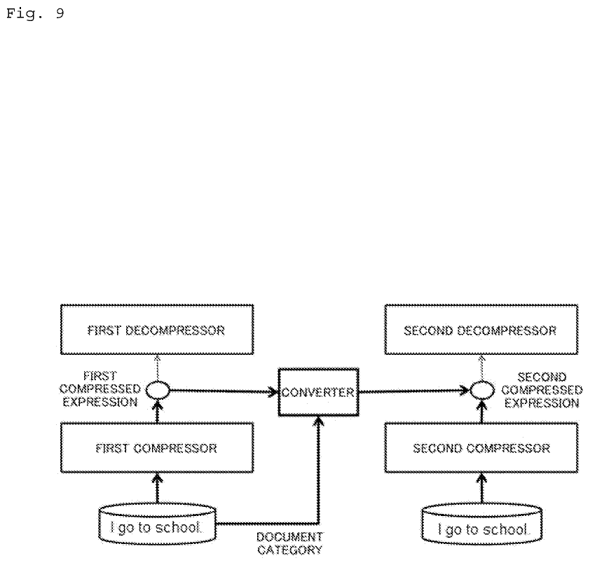

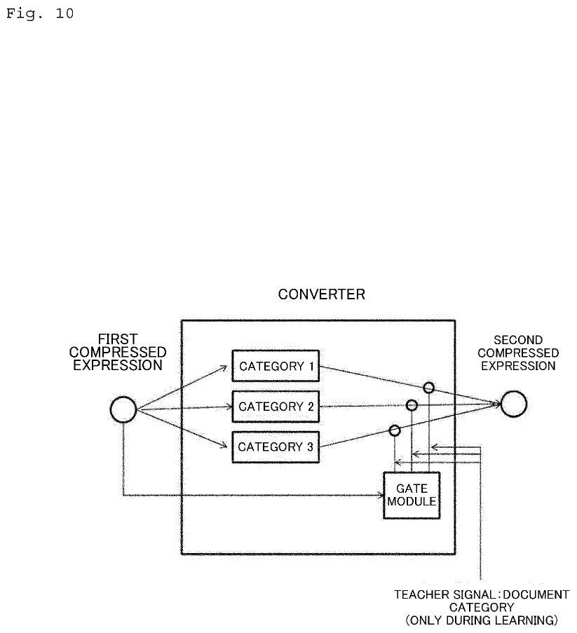

Also, if a document category is provided to the translation data, it is also possible to use a configuration in which the converter is learned for each document category (FIG. 9). In this case, it is possible to learn a different converter for each document category by applying a mixture learning model to the converter. Specifically, the conversion learning unit 111 need only be configured to learn the converter such that the second original sentence compressed expression and the translation compressed expression match for each category. At this time, by learning the document category as the teacher signal of the gate module of the mixture learning model, it is possible to automatically select the converter of the optimal category and convert the compressed information, even if there is no document category information during execution of translation. For example, as shown in FIG. 10, it is possible to realize conversion corresponding to each category due to categories 1 to 3, which are a conversion network, being switched according to the output of the gate module.

Also, in the above-described embodiment, the first-language sentence, the second-language sentence, or the translation data was described as being stored in advance in the first single-language storage unit 101, the second single-language storage unit 105, and the translation storage unit 109, but there is no limitation to this. It is also possible to use a configuration in which input is received sequentially using an external corpus.

Also, in the above-described embodiment, a case in which English was used as the first language and Japanese was used as the second language was described as an example, but it is also possible to use other languages.

Note that the machine translation program obtained by the CPU reading out and executing software (a program) in the above-described embodiment may be executed by various types of processors other than the CPU. A dedicated electrical circuit or the like, which is a processor that has a circuit configuration that is designed specially for executing specific processing, such as a PLD (Programmable Logic Device) and an ASIC (Application Specific Integrated Circuit) whose circuit configuration can be changed after the manufacture of an FPGA (Field-Programmable Gate Array) or the like, is illustrated as the processor in this case. The machine translation program may also be executed by one of these various types of processors, or may be executed by a combination of two or more processors of the same type or different types (e.g., multiple FPGAs, a combination of a CPU and an FPGA, etc.). Also, more specifically, a hardware structure of these various types of processors is an electrical circuit in which circuit elements such as semiconductor elements are combined.

Also, in the above-described embodiments, a mode in which the machine translation program is stored (installed) in advance in the ROM 12 or the storage 14 was described, but there is no limitation to this. The program may also be provided in a form of being stored in a non-transitory storage medium such as a CD-ROM (Compact Disk Read Only Memory), a DVD-ROM (Digital Versatile Disk Read Only Memory), and a USB (Universal Serial Bus) memory. It is also possible to use a mode in which the program is downloaded from an external apparatus via a network.

The following supplementary notes are further disclosed relating to the above-described embodiment.

Supplementary Note 1

A machine translation apparatus including:

a memory; and

at least one processor connected to the memory,

in which the processor is configured to

receive input of an input sentence, which is a sentence that includes at least one or more words and is constituted by a word in a first language,

compress the input sentence to a first compressed expression using a first compressor configured to compress a first-language sentence, which is a sentence that includes at least one or more words and is constituted by a word in the first language, to the first compressed expression, the first compressed expression being an expression in the first language obtained by compressing the first-language sentence,

convert the first compressed expression of the input sentence into a second compressed expression using a converter configured to convert the first compressed expression into the second compressed expression, the second compressed expression being an expression in the second language obtained by compressing a second-language sentence, which is a sentence that includes at least one or more words and is constituted by a word in the second language, and

decompress the second compressed expression converted by the conversion unit to an output sentence, which is the second-language sentence, using a second decompressor for decompressing the second compressed expression to an uncompressed expression.

### REFERENCE SIGNS LIST

10 Machine translation apparatus
11 CPU
12 ROM
13 RAM
14 Storage
15 Input unit
16 Display unit
17 Communication interface
19 Bus
101 First single-language storage unit
102 First compression unit
103 First decompression unit
104 First learning unit
105 Second single-language storage unit
106 Second compression unit
107 Second decompression unit
108 Second learning unit
109 Translation storage unit
110 Conversion unit
111 Conversion learning unit
112 Input unit
113 Output unit

1. A machine translation apparatus comprising a circuit configured to execute a method comprising:
receiving input of an input sentence, which is a sentence that includes at least one or more words and is constituted by a word in a first language;
compressing the input sentence to a first compressed expression using a first compressor configured to compress a first-language sentence, which is a sentence that includes one or more words and is constituted by a word in the first language, to the first compressed expression, the first compressed expression being an expression in the first language obtained by compressing the first-language sentence;
converting the first compressed expression of the input sentence into a second compressed expression using a converter configured to convert the first compressed expression into the second compressed expression, the second compressed expression being an expression in a second language obtained by compressing a second-language sentence, which is a sentence that includes at least one or more words and is constituted by a word in the second language; and
decompressing the second compressed expression to an output sentence, which is the second-language sentence, using a second decompressor for decompressing the second compressed expression to an uncompressed expression.

2. The machine translation apparatus according to claim 1, the circuit further configured to execute a method comprising:
decompressing the first compressed expression compressed by the first compression unit to a first decompressed sentence, which is the first-language sentence, using a first decompressor for decompressing the first compressed expression to an uncompressed expression;
learning the first compressor and the first decompressor such that the input first-language sentence and the first decompressed sentence match;
compressing the input second-language sentence to the second compressed expression using a second compressor configured to compress the second-language sentence to the second compressed expression;
learning the second compressor and the second decompressor such that the input second-language sentence and a second decompressed sentence match, the second decompressed sentence being the second-language sentence; and
learning the converter such that a second original sentence compressed expression and a translation compressed expression match, the second original sentence compressed expression being the second compressed expression obtained by converting a first original sentence compressed expression, which corresponds to a compressed expression of an original sentence, which includes the first-language sentence and the translation compressed expression being an expression obtained by compressing a translation using the second-language sentence of the original sentence, which is the first-language sentence, with the second compressor.

3. The machine translation apparatus according to claim 2, the circuit further configured to execute a method comprising:
prior to the learning the first compressor and the first decompressor, the learning the second compressor and the second decompressor, and the learning the converter, learning a combination of the first compressor, the second decompressor, and the converter using a translation corpus, wherein the translation corpus includes the original sentence and a translation of the original sentence, such that a sentence obtained based on compressing and decompressing the original sentence matches the translation.

4. The machine translation apparatus according to claim 2, wherein at least one of the first compressor, the first decompressor, the second compressor, or the second decompressor includes LSTMs (Long short-time memories), GRUs (Gated Recurrent Units), or multilayer perceptrons.

5. The machine translation apparatus according to claim 2, wherein the converter includes either a multi-layer perceptron or a mixture learning model.

6. The machine translation apparatus according to claim 5, wherein
the converter is based at least on a mixture learning model,
the original sentence and the translation are respectively associated with at least a category, and the circuit further configured to executed a method comprising:
learning the converter such that the second original sentence compressed expression and the translation compressed expression match for each said category.

7. A computer-implemented method for machine translation, comprising:
receiving input of an input sentence, which is a sentence that includes at least one or more words and is constituted by a word in a first language;
compressing the input sentence to a first compressed expression using a first compressor configured to compress a first-language sentence, which is a sentence that includes a word associated with the first language, to the first compressed expression, the first compressed expression being an expression in the first language obtained by compressing the first-language sentence;
converting the first compressed expression of the input sentence into a second compressed expression using a converter configured to convert the first compressed expression into the second compressed expression, the second compressed expression being an expression in a second language obtained by compressing a second-language sentence, which is a sentence that includes at least one or more words and is constituted by a word in the second language; and
decompressing the second compressed expression converted to an output sentence, which is the second-language sentence, using a second decompressor for decompressing the second compressed expression to an uncompressed expression.

8. A computer-readable non-transitory recording medium storing computer-executable machine translation program instructions that when executed by a processor cause a computer system to execute a method comprising:
receiving input of an input sentence, which is a sentence that includes at least one or more words and is constituted by a word in a first language;
compressing the input sentence to a first compressed expression using a first compressor configured to compress a first-language sentence, which is a sentence that includes a word in the first language, to the first compressed expression, the first compressed expression being an expression in the first language obtained by compressing the first-language sentence;
converting the first compressed expression of the input sentence into a second compressed expression using a converter configured to convert the first compressed expression into the second compressed expression, the second compressed expression being an expression in the second language obtained by compressing a second-language sentence including a word associated with the second language; and
decompressing the second compressed expression to an output sentence, which is the second-language sentence, using a second decompressor for decompressing the second compressed expression to an uncompressed expression.

9. (canceled)

10. The machine translation apparatus according to claim 3, wherein the first compressor, the first decompressor, the second compressor, and the second decompressor include LSTMs (Long short-time memories), GRUs (Gated Recurrent Units), or multilayer perceptrons.

11. The computer-implemented method according to claim 7, the method further comprising:
decompressing the first compressed expression compressed by the first compression unit to a first decompressed sentence, which is the first-language sentence, using a first decompressor for decompressing the first compressed expression to an uncompressed expression;
learning the first compressor and the first decompressor such that the input first-language sentence and the first decompressed sentence match;
compressing the input second-language sentence to the second compressed expression using a second compressor configured to compress the second-language sentence to the second compressed expression;
learning the second compressor and the second decompressor such that the input second-language sentence and a second decompressed sentence match, the second decompressed sentence being the second-language sentence; and
learning the converter such that a second original sentence compressed expression and a translation compressed expression match, the second original sentence compressed expression being the second compressed expression obtained by converting a first original sentence compressed expression, which corresponds to a compressed expression of an original sentence, which includes the first-language sentence, and the translation compressed expression being an expression obtained by compressing a translation using the second-language sentence of the original sentence, which is the first-language sentence, with the second compressor.

12. The computer-readable non-transitory recording medium according to claim 8, the computer-executable program instructions when executed further causing the computer system to execute a method comprising:
decompressing the first compressed expression compressed by the first compression unit to a first decompressed sentence, which is the first-language sentence, using a first decompressor for decompressing the first compressed expression to an uncompressed expression;
learning the first compressor and the first decompressor such that the input first-language sentence and the first decompressed sentence match;
compressing the input second-language sentence to the second compressed expression using a second compressor configured to compress the second-language sentence to the second compressed expression;
learning the second compressor and the second decompressor such that the input second-language sentence and a second decompressed sentence match, the second decompressed sentence being the second-language sentence; and
learning the converter such that a second original sentence compressed expression and a translation compressed expression match, the second original sentence compressed expression being the second compressed expression obtained by converting a first original sentence compressed expression, which corresponds to a compressed expression of an original sentence, which includes the first-language sentence, and the translation compressed expression being an expression obtained by compressing a translation using the second-language sentence of the original sentence, which is the first-language sentence, with the second compressor.

13. The computer-implemented method according to claim 11, the method comprising:
prior to the learning the first compressor and the first decompressor, the learning the second compressor and the second decompressor, and the learning the converter, learning a combination of the first compressor, the second decompressor, and the converter using a translation corpus, wherein the translation corpus includes the original sentence and a translation of the original sentence, such that a sentence obtained based on compressing and decompressing the original sentence matches the translation.

14. The computer-implemented method according to claim 11, wherein at least one of the first compressor, the first decompressor, the second compressor, or the second decompressor includes LSTMs (Long short-time memories), GRUs (Gated Recurrent Units), or multilayer perceptrons.

15. The computer-implemented method according to claim 11, wherein the converter includes either a multi-layer perceptron or a mixture learning model.

16. The computer-readable non-transitory recording medium according to claim 12, the computer-executable program instructions when executed further causing the computer system to execute a method comprising:
prior to the learning the first compressor and the first decompressor, the learning the second compressor and the second decompressor, and the learning the converter, learning a combination of the first compressor, the second decompressor, and the converter using a translation corpus, wherein the translation corpus includes the original sentence and a translation of the original sentence, such that a sentence obtained based on compressing and decompressing the original sentence matches the translation.

17. The computer-readable non-transitory recording medium according to claim 12, wherein at least one of the first compressor, the first decompressor, the second compressor, or the second decompressor includes LSTMs (Long short-time memories), GRUs (Gated Recurrent Units), or multilayer perceptrons.

18. The computer-readable non-transitory recording medium according to claim 12, wherein the converter includes either a multi-layer perceptron or a mixture learning model.

19. The computer-implemented method according to claim 13, wherein the first compressor, the first decompressor, the second compressor, and the second decompressor include LSTMs (Long short-time memories), GRUs (Gated Recurrent Units), or multilayer perceptrons.

20. The computer-implemented method according to claim 15, wherein
the converter is based at least on a mixture learning model,
the original sentence and the translation are respectively associated with at least a category, and the method further comprising:
learning the converter such that the second original sentence compressed expression and the translation compressed expression match for each said category.

21. The computer-readable non-transitory recording medium according to claim 18, wherein
the converter is based at least on a mixture learning model,
the original sentence and the translation are respectively associated with at least a category, and the computer-executable program instructions when executed further causing the computer system to execute a method further comprising:
learning the converter such that the second original sentence compressed expression and the translation compressed expression match for each said category.
